(19) United States
(12) Patent Application Publication
(10) Pub. No.: US 2004/0128192 A1
(43) Pub. Date: Jul. 1, 2004

(54) Method and system for advertising and selling product to consumers in a telephone hold queue

(76) Inventors: Michael A Paluszek, Princeton, NJ (US); Christopher G Harvey, Brighton, MA (US); William B Turner, Woodbridge, NJ (US); James A Frueh, Trenton, NJ (US)

Correspondence Address: Richard C Woodbridge, Synnestvedt Lechner & Woodbridge, P O Box 592, Princeton, NJ, 08542-0592, US

(21) Appl. No.: 10/478,533

(22) PCT Filed: May 21, 2002
(86) PCT No.: PCT/US02/16077

(51) Int. Cl. G06F 17/60

(52) U.S. Cl. 705/14

(57) ABSTRACT

A method and system for advertising and selling products while a customer awaits his turn for service in a wait queue. The invention permits the customer to chose to listen to advertisements while in this wait queue. If he chooses these advertisements, the customer then enters the advertisement queue, where the first gets a summary list of ads. The customer then listens to the advertisements(s) he selects. If the customer decides to buy a product, the customer can choose to register with the on-hold add systems permitting future “one-button” purchases. If not, the customer would then enter credit card and shipping information. While in the advertisement queue, the customer continues to advance in the wait queue. The customer is guaranteed to advance at the same rate as if the customer were in the on-hold queue. The customer can choose to leave the ad queue at any time. When the customer's place comes up in the wait queue, the customer is immediately given the option to leave the advertisement queue.

### CROSS REFERENCE TO RELATED APPLICATIONS

This application claims the priority of Provisional U.S. Application Serial No. 60/292,353 filed on May 21, 2001 and entitled: ON HOLD ADVERTISEMENTS by Michael A. Paluszek, Christopher G. Harvey, William A. Turner and James A. Frueh, the entire contents and substance of which are hereby incorporated in total by reference.

### BACKGROUND OF THE INVENTION

1. Field of the Invention

This invention relates to a system and method for advertising to persons who are on telephone hold queues.

2. Description of Related Art

This invention relates to a method for advertising and selling products to customers while they are awaiting service in a hold queue.

Advertising is present in virtually every media. In general, advertisements are most effective when the audience must listen to or view the advertisements. There are few examples in which it is not possible for the audience to avoid viewing or hearing the advertisement. Even in a movie theater, the audience will tend to talk to each other rather than listen to advertisements. In the case of radio, television, magazines, etc. it is a simple matter to ignore advertisements.

Internet advertisements are a case in point in which the user can tune out virtually all ads making them relatively ineffective. Television advertisements are also becoming less effective since viewers who time-shift with a recording device can electronically eliminate advertisements.

There have been various attempts in the prior art to advertise to customers who are captive. An example of which is U.S. Pat. No. 6,377,935 entitled “Method and System for Selective Incentive Point-of-Sale Marketing in Response to Customer Shopping Histories” which issued Apr. 23, 2002 to Deaton et al. This invention provides advertisements to customers purchasing through a point-of-sale system. This invention relates chiefly to the issue of customizing advertising and is only applicable to customers getting printed coupons and similar promotional items at a point-of-sale device.

U.S. Pat. No. 6,385,308, entitled “Telephone System And Method For Personalized Announcements”, issued May 7, 2002 to Cohen et al. relates to a telephone system which provides personalized announcements to calling parties in support of branded products and services during call processing to called parties. While this system provides automated announcements, it fails to deliver advertising to permit the listener to take any action with regard to the announcement.

U.S. Pat. No. 6,385,592, entitled “System And Method For Delivering Customized Advertisements Within Interactive Communication Systems”, issued May 7, 2002 to Paul Angles relates to a system and method for delivering customized electronic advertisements in an interactive communication system. The customized advertisements are selected based on consumer profiles and are then integrated with offerings maintained by different content providers. While this invention relates to delivering advertising in an interactive session, it also fails to provide the customer with a mechanism to take action based on the advertisement.

A need exists in the prior art to provide captive customers with an interactive means to select advertising of interest and to readily make purchases should they desire.

### SUMMARY OF THE INVENTION

Briefly described, the invention comprises a system of advertising to customers while they are waiting for service in a queue, such as a hold queue relating to a telephone call. Customers who are interested in listening to advertisements are put on a separate advertising queue where they listen to advertisements. They can choose to buy a product and order the product using a credit card or with account information stored on a central server. In one embodiment of the invention, customers are permitted to select advertisements of interest thus making their wait less tedious. In an additional embodiment customers who listen to advertisements are guaranteed a shorter wait than those who do not. Customer actions can be via the phone keypad, a touch-pad on an LCD screen or by voice command.

### BRIEF DESCRIPTION OF THE DRAWINGS

FIG. 1 illustrates the system.

FIG. 2 illustrates the flow in the no advertising and advertising queue.

FIG. 3 illustrates the purchasing flow chart.

FIG. 4 illustrates the customer response system.

### DESCRIPTION OF THE PREFERRED EMBODIMENT

During the course of this description like numbers will be used to identify like elements according to the different views which illustrate the invention.

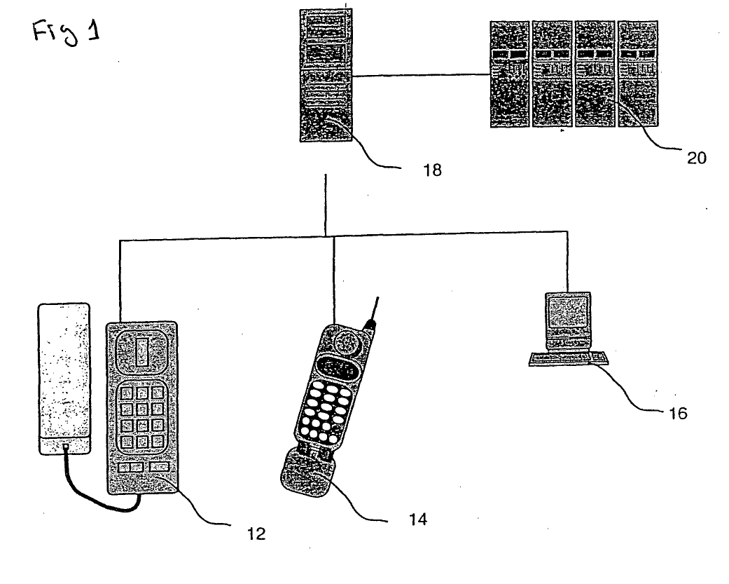

As illustrated in FIG. 1, the present invention relates to a device for a customer to join a hold queue. This can be a telephone 12, a cell phone 14 or a personal computer 16. The customer contacts a company through any of these devices and is put on hold while waiting for help. The customer may have to navigate through various options before being put on a hold queue. The hold queue is managed by a local computer 18, which also contains the advertisements. This computer is connected to a server 20, which contains credit card and shipping information for the customer, if it is available.

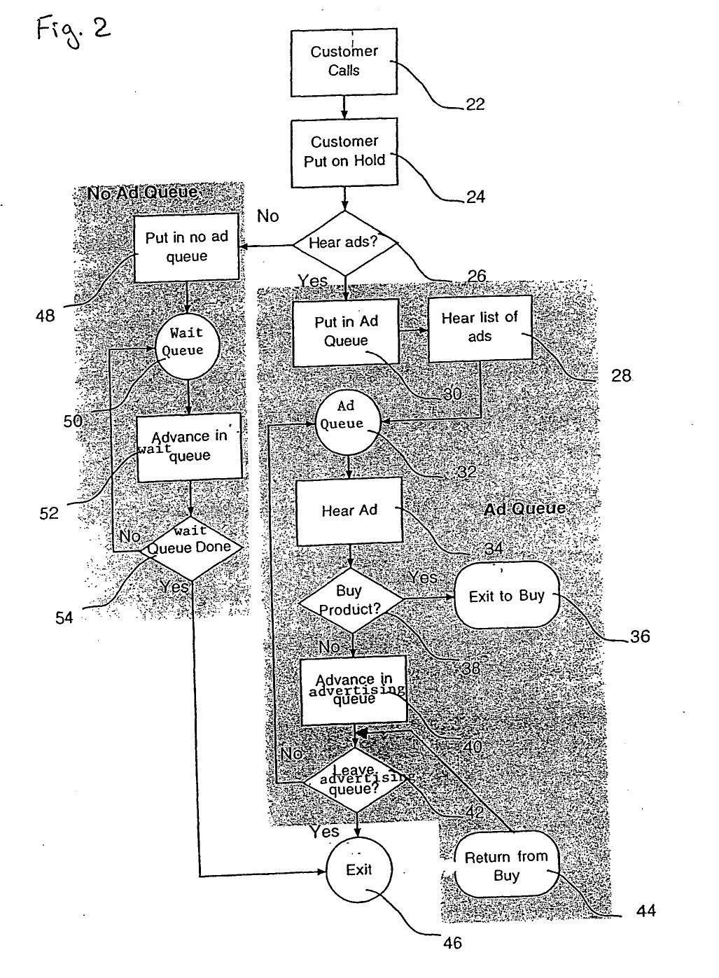

In the embodiment of the invention depicted in FIG. 2, the customer calls 22 a telephone number which has a queue on which the customer must wait before receiving service. The customer is put on hold 24 and given an approximate wait time. At that point the customer is given the option of listening to advertisements 26. If the customer does not want to listen to advertisements, the customer takes no action and is put in the no ad queue 48. If the customer wants to listen to advertisements, the customer says yes or pushes a button on the telephone 30. The customer who selects advertisements is given a list of advertising organized by category 28. For example, one category might be travel, another small kitchen appliances. The customer enters the queue 32, and listens to the advertisements 34. After each ad, the customer is given an indication of the customer's position in the wait queue. If the customer wants to buy a product the customer pushes a button corresponding to the product or speaks the product's name 38. This puts the customer into purchase mode 36. Otherwise, the customer stays on the queue and listens to other advertisements.

While listening to advertisements, the customer advances in the advertising queue 40. The customer can leave the queue at any time 42. When the user leaves the advertising queue 46, the customer returns to the wait queue. However, the customer's position is advanced. Otherwise, the user stays in the advertising queue 32. When the customer returns from purchase mode 44, the customer may stay in the advertising queue or move to the standard wait queue. In the standard wait queue the user advances in the queue 52, until the queue is done. Otherwise, the user remains in the advertising queue 32 until the customers turn arrives.

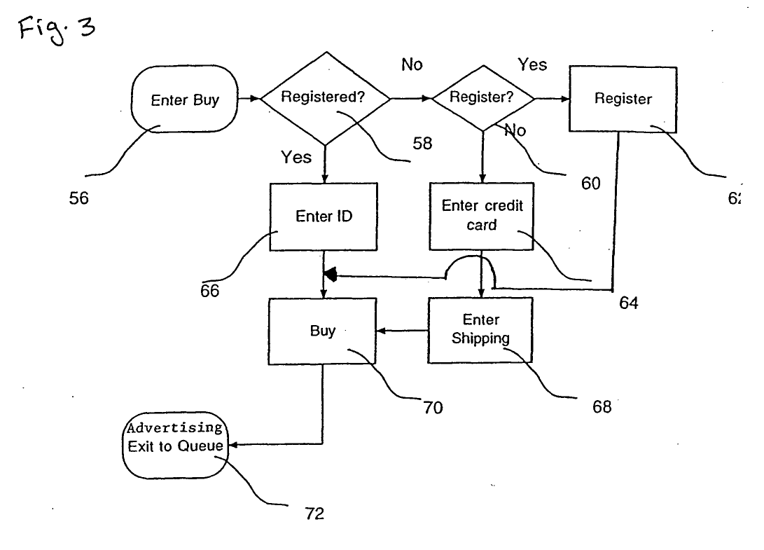

As depicted in FIG. 3, if the customer decides to buy, the customer enters the buying queue 56. The customer is asked for an ID number 58. If the customer has one, the customer enters the identification 66 and buys the product 70. The customer then returns to the advertising queue 72. If the customer does not have an ID number 58, the customer is given the option to register 60. If the customer chooses to register 62, the customer enters credit card and shipping information. The customer can also enter this information by going to a secure website. The registration information is stored in a central server common to all “on-hold advertising queues”. Thus, the customer never has to enter this information more than once. This also allows the system to easily verify customer information thus reducing opportunities for fraud. If the customer does not wish to register, the customer may enter credit card information 64 and shipping information 68 either verbally or by pushing keys on the phone keypad. The customer may then buy 70 the product and exit the purchase queue 72.

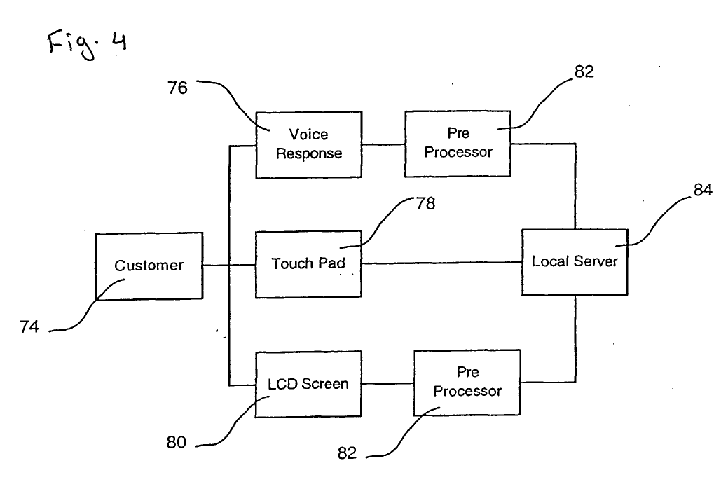

In the embodiment of the invention depicted in FIG. 4, the customer 74, can use a telephone keypad 78, voice recognition 76 or the LCD screens of cell phones 82. If the voice response is used, the response is preprocessed to identity the equivalent keypad response 82. If the LCD or keyboard input is used, this is preprocessed to identity the equivalent keypad response 82. A spoken or LCD input might be equivalent to several keypad touches. The response is passed to the local server 84.

The invention 10 has several distinct advantages over prior art advertising. First, the audience cannot ignore the message without losing his or her place in the telephone wait queue. Second, the advertisements would make the time on hold seem less onerous giving the audience a positive frame of mind, in contrast to the annoyance most people feel at commercials on television or radio. Third, the time on hold is often an expense to the company that the person is calling. This system turns that time into a source of revenue since the time is sold to the advertiser making it very attractive to the company with the telephone queue. Fourth, since the advertisements are audio-only they would be much less expensive to produce than other forms of advertising. Fifth, a mechanism is provided for immediate sales. This “one-touch” sales mechanism is simpler than other methods that are provided by television advertisements and other media.

While the invention has been described with reference to the preferred embodiment thereof it will be appreciated by those of ordinary skill in the art that modifications can be made to the parts that comprise the invention without departing from the spirit and scope thereof.

1. A system for permitting a customer to elect receiving advertisements while the customer is waiting his turn for service in a wait queue, said advertisements contained in an advertising queue, said system comprising the following components:
a customer input device;
a local server for serving the advertisements and managing the advertising queue and the wait queue;
a central server for storing credit card and shipping information.

2. The system of claim 1 wherein the input device is selected from the group consisting of a telephone keypad, telephone handset, computer keyboard, microphone, and an LCD touchpad.

3. The system of claim 2 wherein the local server puts the customer back in the wait queue in the same or higher position than when the customer first elected receipt of the advertisements.

4. The system of claim 2 wherein the central server permits the customer to record credit card and shipping information on a central secure server.

5. The system of claim 4 further comprising a plurality of local servers and wherein the information is accessible from each of said local servers.

6. The system of claim 5 wherein the information can be updated by the customer via the Internet.

7. A method for advertising to a customer while the customer is on hold in a wait queue, the method comprising the following steps:
presenting the customer with advertising and ordering options;
enabling the customer to order advertised products;
maintaining a position for the customer in the wait queue.

8. The method of claim 7 wherein said presenting step comprises permitting the customer to choose to listen to advertisements.

9. The method of claim 8 wherein different advertisement tracks can be heard.

10. The method of claim 9 wherein the maintaining step comprises monitoring the customer's position in wait queue and permitting the customer to leave the presenting step when the customer is due to be served.

11. The method of claim 10 wherein the maintaining step further comprises accelerating the customer's movement through the wait queue if the customer chooses to listen to advertisements.

12. The method of claim 10 wherein the maintaining step further comprises moving the customer through the wait queue at the same rate whether or not the customer had chosen to listen to advertisements.

13. The method of claim 10 wherein the step of enabling the customer to order advertised products comprises the step of using previously stored credit card and shipping information.

14. The method of claim 10 wherein the step of enabling the customer to order advertised products comprises allowing the customer to enter shipping and credit card information each time the customer orders a product.
